(19) United States
(12) Patent Application Publication
(10) Pub. No.: US 2026/0324585 A1
(43) Pub. Date: Oct. 22, 2026

(54) Pet Litter Containing Aerated Clay Particles

(71) Applicant: Boxiecat LLC, Santa Monica, CA (US)

(72) Inventors: Alvin Kershman, St. Louis, MO (US); Jeff Shear, Bonita Springs, FL (US); William Lewis, Pacific, MO (US)

(73) Assignee: Boxiecat LLC, Santa Monica, CA (US)

(21) Appl. No.: 19/650,444

(22) Filed: Apr. 17, 2026

Related U.S. Application Data
(60) Provisional application No. 63/792,014, filed on Apr. 21, 2025.

(51) Int. Cl. A01K 1/015

(52) U.S. Cl. CPC A01K 1/0154; A01K 1/0155

(57) ABSTRACT

A cat litter comprising a solid water-absorbent material and aerated clay particles, wherein the aerated clay particles have a density of from about 500 to 900 g/L density, and wherein the at least one aerated clay absorbs 10 wt. % or more of water when immersed in water for from one five seconds.

### CROSS-REFERENCE TO RELATED APPLICATIONS

This is a patent application claims the benefit of provisional patent application 63/792,014 filed Apr. 21, 2025, which is hereby incorporated by reference.

### STATEMENT REGARDING FEDERALLY SPONSORED RESEARCH

### Not Applicable.

### APPENDIX

Not Applicable.

### BACKGROUND OF THE INVENTION

### Field of the Invention

The present disclosure relates generally to pet litter compositions containing aerated clay particles, and methods that make the aerated clay particles absorbent and suitable for the cat litter.

### Related Art

Litter boxes are used by cats for elimination of urine and fecal matter. A litter box contains a layer of cat litter that receives the urine and fecal matter. Typically the cat litter is particular and absorbent to facilitate formation of clumps after the urine and fecal matter is deposited in the cat litter. The clumps are typically sifted from the litter box using a litter scoop and then discarded.

Cat litter is heavy and the cost of shipping can be high. Aerated clay is less dense than most clay-based cat litter and can cost less to ship. Additionally, aerated clay has interstitial spaces that can be used to hold and deliver additives to improve the performance of the clay.

It is known that various additives, such as probiotics, indicators, fragrances, etc. used in cat litter reduce the urine and fecal odor, and provide other benefits. There are several ways known in the art to incorporate these additives in cat litter. The powdered additives can simply be sprinkled on top of the cat litter. Alternatively, the additives can be coated onto the cat litter which is subsequently granulated. There are numerous reasons that these approaches are ineffective, which include particle segregation and loss of coating due to particle deterioration caused by jostling and crushing when shipping.

Aerated solids are well known in the art. Clay aerogels and clay aerogel/polymer composites represent a relatively new family of low density materials created through ice templating. The use of water soluble polymers and sodium montmorillonite can create materials with mechanical properties similar to typical foamed polymers. When the composites are created from aqueous solutions, the resulting composites are water absorbent.

Aerogels are formed when the liquid within a gel is removed and replaced with a gas in such a way as to prevent shrinking of the structure. This technique involves freeze drying the gel. The most common aerogels are made of silicon dioxide, silica, and have a string of pearls type nanoscale structure. Xerogels have a similar structure but are denser than aerogels and are often formed by allowing the gel to dry at ambient pressure rather than supercritical drying. Xerogels made with clay are significantly less expensive than aerogels due to the lack of supercritical drying. They have been disclosed as useful for household animal waste. However, the process still involves freezing the gel before drying. The freeze dried clay has a density of less than 100 g/L, which is an unfavorable density for use as cat litter.

The present invention provides a stable, aerated form of clay particle suitable for cat litter. It is desirable that the aerated clay particle be absorbent and that it form clumps when wetted. In a preferred embodiment, beneficial additives, which give desirable properties, can be incorporated into the aerated clay.

### SUMMARY OF THE INVENTION

The present invention is an improved cat litter which comprises aerated clay particles wherein the aerated clay particles consist of clay and optionally up to 10 wt. % surfactant. The aerated clay is liquid-absorbent. Preferably, the aerated clay absorbs at least 10 wt. % water in about 1 second of immersion. More preferably, the aerated clay absorbs at least 20 wt. % water in about 1 second of immersion. The aerated clay is preferably formed by forming an aqueous gel of the clay, mechanically aerating the gel, and drying the aerated gel to form the aerated clay having a reduced bulk density.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

The following description of the preferred embodiment(s) is merely exemplary in nature and is in no way intended to limit the invention, its application, or uses.

The claimed pet litter comprises at least one absorbent material and at least one aerated clay particle. In a preferred embodiment the at least one absorbent material is also the aerated clay particle. The absorbent material can be any water-absorbent material or combination of absorbent materials commonly used in litters. Typically, the absorbent material is a dry, granular material. Preferably, said absorbent material is selected from the group consisting of clays, silica gels, woods (such as pine, aspen, cedar, fir, spruce), agricultural products, and combinations thereof. More preferably, said absorbent material is selected from the group consisting of clays, silica gels, pumice, absorbent foamed materials, and combinations thereof. In a particular embodiment, the absorbent material is clay, such as calcium or sodium montmorillonite (including sodium bentonite and calcium bentonite), smectite, ventriculite, attapulgite, opal clay and/or kaolin. The absorbent material, in particular clays, can be clumping and/or non-clumping. In a quick absorption test, the preferred absorbent material absorbs 10 wt. % or more of its weight with water after being submerged in water for from one to five seconds.

Preferably, the aerated clay is not formulated with a binder such as lactose, corn starch, or a cellulosic polymer, for example, hydroxypropylmethylcellulose (HPMC), hydroxypropylcellulose (HPC), hydroxyethylcellulose, methylcellulose and/or ethylcellulose. The binder can cause difficulty in filling and emptying the mold, as it often does not release the particle completely. In the event that a binder is used in the aerated clay, preferably 5.0 wt. % or less is used. In a preferred embodiment, the binder is present in the aerated clay from about 0 to 1 wt. %.

The aerated clay particles are made with a clay and optionally contains up to 10.0 wt. % surfactant. The clay material is selected from the group that includes calcium or sodium montmorillonite (including sodium bentonite and calcium bentonite), smectite, ventriculite, attapulgite, opal clay and/or kaolin. The clays can be clumping and/or non-clumping, but clumping clays are preferred. The most preferred clay is sodium bentonite. In a quick absorption test, the preferred aerated clay absorbs at least 10 wt. % of its weight with water after being submerged in water for from one to five seconds. A more preferred aerated clay absorbs 20 wt. % or more of its weight in water after being submerged in water for about one second. A most preferred aerated clay absorbs 25 wt. % or more of its weight in water after being submerged in water for one second.

The surfactant of the present invention includes nonionic surfactants, anionic surfactants, cationic surfactants and amphoteric surfactants. The nonionic surfactants have no charge on their hydrophilic head and are often used as co-surfactants or for gentle cleaning. The anionic surfactants have a negatively charged hydrophilic head and are known for their strong cleaning and emulsifying properties. The cationic surfactants have a positively charged hydrophilic head and are often used for their antibacterial and conditioning properties. The amphoteric surfactants have both a positive and a negative charge on their hydrophilic head, making them versatile and suitable for various applications. A preferred anionic surfactant is sodium lauryl sulfate. The preferred amount of sodium lauryl sulfate is from about 0.01 to 5.0 wt. % of the clay gel. The preferred amount of sodium lauryl sulfate in the dried aerated clay particle is from about 0.1 to 10.0 wt. %.

The density of the aerated clay is less than the non-aerated clay. Typical cat litter (non-aerated) has a density of from about 910-1200 g/L. Preferably, the aerated clay has a density of from 900 to 250 g/L. Clay having a density less than 250 g/L creates a cat litter that is so light it tends to track out of the litter box. Cats don't like the feel of litter sticking to their paws and are more reluctant to use litter that is 250 g/L or less. More preferably, the density is from 900 to 600 g/L.

The beneficial additives can include fragrances, color indicators, pheromones, probiotics, and others. The probiotic beneficial additive which reduces odor can be selected from a wide variety of bacteria and mixtures of bacteria. A number of urease negative organisms are known and are suitable for use as a probiotic in a litter product. Among them are strains selected from group N streptococcus, such as Lactococcus lactis; group D streptococcus, such as Streptococcus faecium; pediococcus such as Pediococcus acidilactici, Pediococcus cerevisiae, and Pediococcus pentosaeceus; propionibacterium such as Propionibacterium shermanii and Propionibacterium freudenreichii; leuconostoc; and lactobacillus such as Lactobacillus acidophilus and Lactobacillus bulgaricus. Other nonspecific bacillus type organisms of compost and soil origin also are candidates. The probiotics comprise any one or combination of at least two of Bifidobacterium animalis, lactobacillus or Enterococcus faecalis. Other probiotics are contemplated in the present invention. A preferred amount of probiotic bacteria in the aerated particle is from about 0.01 to 25 wt. %. A more preferred amount of probiotic bacteria is from 0.01 to 5.0 wt. %.

The most common method for aerating the clay is to combine the clay with water to from a gel. The optional surfactant is added to the gel. The gel is the whipped using a mixer such as a Hobart mixer, to form the aerated gel, which is placed in a form and dried at room temperature (20-22° C. or 68 to 72° F.) at atmospheric pressure for from 3 to 6 days. The drying time can be decreased if the pressure is decreased and/or the temperature increased. The aerated clay particles of the present invention are not made by freezing or freeze drying. Preferably, the gel contains from 50 to 80 wt. % water. More preferably, the gel contains from 55 to 75 wt. % water. The aerated clay particles are determined to be dry when after weighing the drying aerated gel on three consecutive days, the weight does not decrease.

In a preferred embodiment, the aerated gel is created as a bulk product and dried. The dried bulk product is crushed and sieved into the desired sized aerated clay particles.

In a preferred embodiment, the particle size of the aerated clay falls within the average particle size for the cat litter itself. In a preferred embodiment, the particle size of the cat litter ranges between a 10 and a 30 mesh screen size.

Aerated clay particles were made of the following compositions given in Table 1.

### Examples 1-5

The clay used in Examples 2-5 was BigHorn™ 40, which is granulated sodium bentonite clay that passed through a 40 mesh screen. For Example 1, the clay was Boxiecat® granulated cat litter. The density of the dry clay was from about 1000 to 1100 g/L. The clays were mixed with deionized water to form a homogeneous gel mixture. Optionally, sodium lauryl sulfate surfactant was added to the mixture. The mixture was whipped with a Hobart mixer to from a foam. The foam was added to a 0.25 inch×0.25 inch×0.25 inch cube-shaped form and dried at room temperature and pressure to form the aerated clay particles. The formed particles were weighed daily until the weight stopped decreasing indicating dryness.

TABLE 1

| | Example 1 - | | | | |
|---|---|---|---|---|---|
| | Boxiecat ® | Exam- | Exam- | Exam- | Exam- |
| | litter | ple 2 | ple 3 | ple 4 | ple 5 |
| Clay | 20.70 | 38.73 | 38.54 | 29.64 | 29.50 |
| Water | 79.30 | 61.27 | 60.97 | 69.86 | 69.50 |
| Surfactant - | | | 0.49 | 0.50 | 1.00 |
| Sodium | | | | | |
| Lauryl | | | | | |
| Sulfate | | | | | |
| Density (g/L) | | | 906 | 680 | 774 |
| after drying | | | | | |
| Absorptivity | | | 25.4 | 25.5 | |
| (wt. % | | | | | |
| absorbed) | | | | | |

The amounts of clay, water and surfactant are given in weight % of the clay gel.

The amount of clay in the gel is from about 20 to 70 wt. %. A preferred amount of clay in the gel is from about 20 to 50 wt. %.

The water absorption test was measuring the weight of the aerated particles in a mesh basket and immersing the basket in room temperature water for about 1 second. The short amount of time allowed for absorption was chosen to simulate a cat urinating on the litter and rapidly activating the beneficial additive such as probiotics. The basket was removed, allowed to drip for 5 seconds and then weighed. The absorbed water of the wetted particles was determined. Untreated Boxiecat® litter had an absorptivity of 68.6 to 79.8 wt. %.

The data shows that a lower density, absorbent clay particle can be made using the method of the present invention.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A cat litter comprising at least one solid water-absorbent material and aerated clay particles, wherein the aerated clay particles have from about 100 to 900 g/L density, from 0 to 10 wt. % surfactant, from 0 to 10 wt. % beneficial additive, and are water absorptive.

2. The cat litter of claim 1, wherein the beneficial additive is at least one probiotic in the range of 0.01 to 5.0 wt. % of the aerated clay particles.

3. The cat litter of claim 1, wherein the clay is sodium bentonite clay.

4. The cat litter of claim 1, wherein the solid water-absorbent material is selected from the group consisting of clays, silica gels, woods, agricultural products, pumice, absorbent foamed materials, and combinations thereof.

5. The cat litter of claim 4, wherein the at least one water-absorbent material consists of the aerated clay particles.

6. The cat litter of claim 5, wherein the aerated clay particles have a density of from about 500 to 900 g/L density;
wherein the aerated clay particles have from 0.01 to 10 wt. % surfactant; and
wherein the aerated clay particles absorb 10 wt. % of its weight or more of water when immersed in water for from one to five seconds.

7. A cat litter comprising at least one solid water-absorbent material and aerated clay particles, wherein the aerated clay particles have a density of from about 500 to 900 g/L density;
wherein the at least one aerated clay absorbs 10 wt. % or more of water when immersed in water for from one to five seconds; and
wherein the aerated clay particles have from 0 to 10 wt. % surfactant.

8. The cat litter of claim 7, wherein the aerated clay particles contain from 0 to 5.0 wt. % binder.

9. The cat litter of claim 8, wherein the surfactant in the aerated clay particles comprises sodium lauryl sulfate.

10. The cat litter of claim 9, wherein the clay in the aerated clay particles comprises sodium bentonite.

11. A method of making cat litter comprising aerated clay particles comprising:
mixing a clay and water together to form a gel,
adding a surfactant to the gel,
whipping the gel to aerate, and
drying the gel to form the aerated clay particles,
wherein the amount of clay in the gel is from about 20 to 70 wt. %;
wherein the amount of surfactant in the gel is from 0 to 5.0 wt. %;
wherein the aerated clay particle has a density of from about 100 to 900 g/L; and
wherein the aerated clay particles absorbs 10 wt. % of its weight or more of water when immersed in water for from one second.

12. The method of claim 11, wherein the gel is not frozen before drying.

13. The method of claim 12, wherein the gel is dried at room temperature.

14. The method of claim 13, wherein the clay is sodium bentonite.

15. The method of claim 14, wherein the surfactant is sodium lauryl sulfate.
